(19) United States
(12) Patent Application Publication
(10) Pub. No.: US 2023/0297124 A1
(43) Pub. Date: Sep. 21, 2023

(54) OPERATION MANAGEMENT DEVICE AND OPERATION MANAGEMENT METHOD

(71) Applicant: KDDI CORPORATION, Tokyo (JP)

(72) Inventors: Takaya TANAKA, Tokyo (JP); Hiroshi KAWANA, Tokyo (JP)

(73) Assignee: KDDI CORPORATION, Tokyo (JP)

(21) Appl. No.: 18/104,441

(22) Filed: Feb. 1, 2023

(30) Foreign Application Priority Data
Mar. 18, 2022 (JP) 2022-043401

(51) Int. Cl. G05D 1/10

(52) U.S. Cl. CPC G05D 1/106

(57) ABSTRACT

An operation management device includes: a condition storage unit that stores a performance condition required for a mobile object that moves at each of the plurality of positions; an application acceptance unit that accepts application data for requesting permission for an applying mobile object to move, and movement range data indicating an area in which the applying mobile object is desired to move; and a movement permission unit that executes processing of permitting a movement corresponding to the application data if performance of the applying mobile object included in the application data or performance of the applying mobile object stored in a mobile object information storage unit in association with a flight vehicle ID satisfies the performance condition stored in the condition storage unit in association with one or more positions included in a desired movement area indicated by the movement range data.

### CROSS REFERENCE TO RELATED APPLLICATION

Priority is claimed on Japanese Patent Application No. 2022-043401, filed Mar. 18, 2022, the content of which is incorporated herein by reference.

### BACKGROUND OF THE INVENTION

### Field of the Invention

The present invention relates to an operation management device and an operation management method for managing operations of mobile objects.

### Description of Related Art

Heretofore, there have been known systems that decide whether or not to permit the movement of a mobile object depending on whether or not the position where the mobile object is flying is in a flight restricted area (for example, see International Publication No. WO2017/013858).

### SUMMARY OF THE INVENTION

Therefore, an exemplary object of the present invention is to enable a mobile object suitable for an area to move within the area.

An operation management device of a first exemplary aspect of the present invention includes: a condition storage unit that stores, in association with a plurality of positions, a performance condition required for a mobile object that moves at each of the plurality of positions; an application acceptance unit that accepts application data for requesting permission for an applying mobile object to move, and movement range data indicating an area in which the applying mobile object is desired to move; and a movement permission unit that executes processing of permitting a movement corresponding to the application data if performance of the applying mobile object included in the application data or performance of the applying mobile object stored in a mobile object information storage unit in association with mobile object identification information for identifying the applying mobile object included in the application data satisfies the performance condition stored in the condition storage unit in association with one or more positions included in a desired movement area indicated by the movement range data.

The movement permission unit may execute the processing of permitting a movement corresponding to the application data if the performance of the applying mobile object satisfies the strictest performance condition among a plurality of the performance conditions stored in the condition storage unit in association with a plurality of positions included in the desired movement area.

The condition storage unit may further store a required weather condition indicating a weather condition under which the mobile object is permitted to move at each of the plurality of positions, and the movement permission unit may execute the processing of permitting a movement corresponding to the application data if the weather status at one or more positions included in the desired movement area included in the application data further satisfies the required weather condition stored in the condition storage unit in association with the one or more positions.

The condition storage unit may store the performance condition in further association with a weather status, and the movement permission unit may execute the processing of permitting a movement corresponding to the application data if the performance condition stored in the condition storage unit in association with the weather status at one or more positions included in the desired movement area included in the application data is satisfied.

The condition storage unit may store the performance condition in further association with a date or a time of day, and the movement permission unit may execute the processing of permitting a movement corresponding to the application data if the performance condition stored in the condition storage unit in association with desired movement date and time included in the application data is satisfied.

The condition storage unit may store the performance condition in further association with a purpose or an operation type of the mobile object, and the movement permission unit may execute the processing of permitting a movement corresponding to the application data if the performance condition stored in the condition storage unit in association with a purpose or an operation type included in the application data is satisfied.

The operation management device may further include: a data acquisition unit that acquires data indicating the number of mobile objects that are moving at positions within a predetermined distance from the plurality of positions; and a condition decision unit that decides the performance condition associated with the plurality of positions, based on the number of mobile objects indicated by the data acquired by the data acquisition unit.

The application acceptance unit may, before accepting the application data, transmit the performance condition to an information terminal that transmits the application data in association with at least some positions of the plurality of positions.

The application acceptance unit may, before accepting the application data, accept the movement range data from the information terminal and transmit the performance condition to the information terminal in association with one or more positions included in this movement range data.

An operation management method of a second exemplary aspect of the present invention includes computer-executed steps of: accepting application data for requesting permission for an applying mobile object to move, and movement range data indicating an area into which the applying mobile object is desired to move; and executing processing of permitting a movement corresponding to the application data if performance of the applying mobile object included in the application data or performance of the applying mobile object stored in a mobile object information storage unit in association with mobile object identification information for identifying the applying mobile object included in the application data satisfies the performance condition stored in the condition storage unit in association with one or more positions included in a desired movement area indicated by the movement range data, as the performance condition required for a mobile object that moves at one or more of the positions.

### BRIEF DESCRIPTION OF THE DRAWINGS

FIG. 1 is a diagram showing a configuration of an operation management system S according to a first exemplary embodiment.

FIG. 2 is a diagram showing a configuration of an operation management device 1.

FIG. 3 is a diagram showing an example of performance condition data.

FIG. 4 is a diagram showing an example of flight vehicles data.

FIG. 5 is a diagram showing an example of a path corresponding to movement range data.

FIG. 6 is a diagram showing an example of an image indicating a recommended position.

FIG. 7 is a flowchart showing the flow of processing of the operation management device 1.

FIG. 8 is a diagram showing a configuration of an operation management device 1a according to a second exemplary embodiment.

### DETAILED DESCRIPTION OF THE INVENTION

### First Exemplary Embodiment

### Overview of Operation Management System S

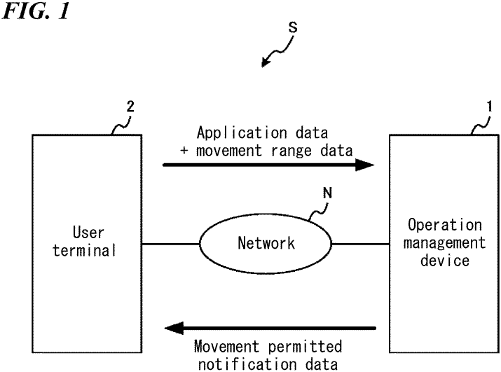

FIG. 1 is a diagram showing a configuration of an operation management system S according to a first exemplary embodiment. The operation management system S is a system that permits the movement of a mobile object if the performance of the mobile object satisfies the performance condition required in the area in which the mobile object is scheduled to move.

The moving object is a device that can move its location, such as an unmanned flight vehicle such as a drone, an automobile, or a ship. While the present specification exemplifies a case where the mobile object is a flight vehicle (for example, a drone) and the flight vehicle moves by flight, the mobile object may be other than a flight vehicle. While the following description exemplifies a case where a user flies a flight vehicle, the present exemplary embodiment can also be applied to a case where a user moves a mobile object other than a flight vehicle.

The operation management system S includes an operation management device 1 and a user terminal 2. The operation management device 1 receives, from the user terminal 2 used by the user of an applying flight vehicle D, which is an applying mobile object, application data for requesting permission to fly the applying flight vehicle D. The application data includes at least either one of data indicating the performance of the applying flight vehicle D and a flight vehicle ID that is mobile object identification information for identifying the applying flight vehicle D.

The user terminal 2 is an information terminal with which a user can transmit and receive data, such as a computer or a smartphone. The operation management device 1 and the user terminal 2 transmit and receive data to and from each other via a network N (for example, the Internet).

The operation management device 1 receives, from the user of the applying flight vehicle D, movement range data indicating an area in which the applying flight vehicle D is desired to fly. The operation management device 1 may receive the movement range data at the same time as the application data, or may receive the movement range data before or after the application data.

The area in which the applying flight vehicle D is desired to fly is a two-dimensional region or a three-dimensional region including: a path that includes a plurality of positions through which the applying flight vehicle D is scheduled to pass from the start of flight to the end of flight; or these plurality of positions.

The movement range data is, for example, data indicating the latitude and longitude of a plurality of positions through which the applying flight vehicle D is scheduled to pass from the start of flight to the end of flight, or data indicating the latitude and longitude of a plurality of positions on the outer perimeter of a two-dimensional region.

The movement range data may also include altitude in addition to latitude and longitude. Also, in the case where the applying flight vehicle D is preliminarily determined to fly linearly, the movement range data may include only the latitude and longitude of the position at which the applying flight vehicle D starts flying and the latitude and longitude of the position at which the applying flight vehicle D ends flying. Moreover, in the case where the operation management device 1 stores an area ID, which is information for identifying an area, and information indicating the position of the area in association with each other, the area ID may be used as movement range data. It should be noted that the movement range data may include, in association with a plurality of positions, movement date and time data indicating the date and time on and at which the applying flight vehicle D is scheduled to pass through each of those positions.

Upon receiving the application data, the operation management device 1 determines whether or not the performance of the applying flight vehicle D satisfies the performance condition required for a flight vehicle to fly through the position indicated by the movement range data. The operation management device 1 stores, in association with a plurality of positions, performance conditions such as wind resistance performance, temperature resistance performance, and water resistance performance required for a flight vehicle to fly at each of the positions. The details of this will be described later.

The operation management device 1 compares the performance of the applying flight vehicle D with the required performance condition to determine whether or not the performance of the applying flight vehicle D satisfies the required performance condition. If the performance of the applying flight vehicle D satisfies the required performance condition, the operation management device 1 executes the processing of permitting flight of the applying flight vehicle D. The operation management device 1, for example, transmits movement permitted notification data to the user terminal 2, and provides the administrator of the flight vehicle flying within the jurisdictional area with information related to the flight vehicle permitted to fly.

Hereinafter, the configuration and operations of the operation management device 1 will be described in detail.

### Configuration of Operation Management Device 1

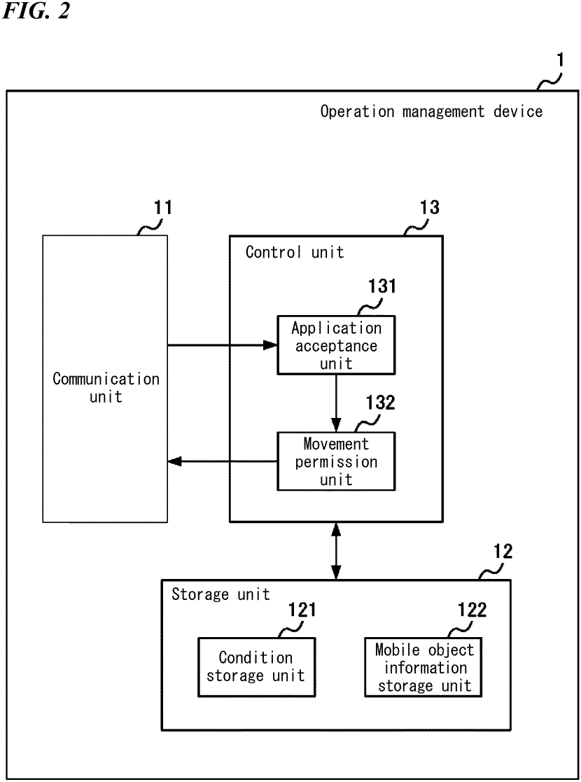

FIG. 2 is a diagram showing a configuration of the operation management device 1. The operation management device 1 has a communication unit 11, a storage unit 12, and a control unit 13.

The communication unit 11 receives various types of data from the user terminal 2 via the network N and transmits various types of data to the user terminal 2. For example, the communication unit 11 receives application data and movement range data from the user terminal 2 and transmits movement permitted notification data to the user terminal 2.

The storage unit 12 includes a storage medium such as a ROM (Read Only Memory), RAM (Random Access Memory) and SSD (Solid State Drive). The storage unit 12 stores a program executed by the control unit 13. Moreover, the storage unit 12 stores various types of data necessary for the control unit 13 to determine whether or not to permit the applying flight vehicle D to fly.

The storage unit 12 has a condition storage unit 121 and a mobile object information storage unit 122. The condition storage unit 12 stores, in association with a plurality of positions, performance condition data indicating the performance condition required for a flight vehicle to fly at each of the plurality of positions.

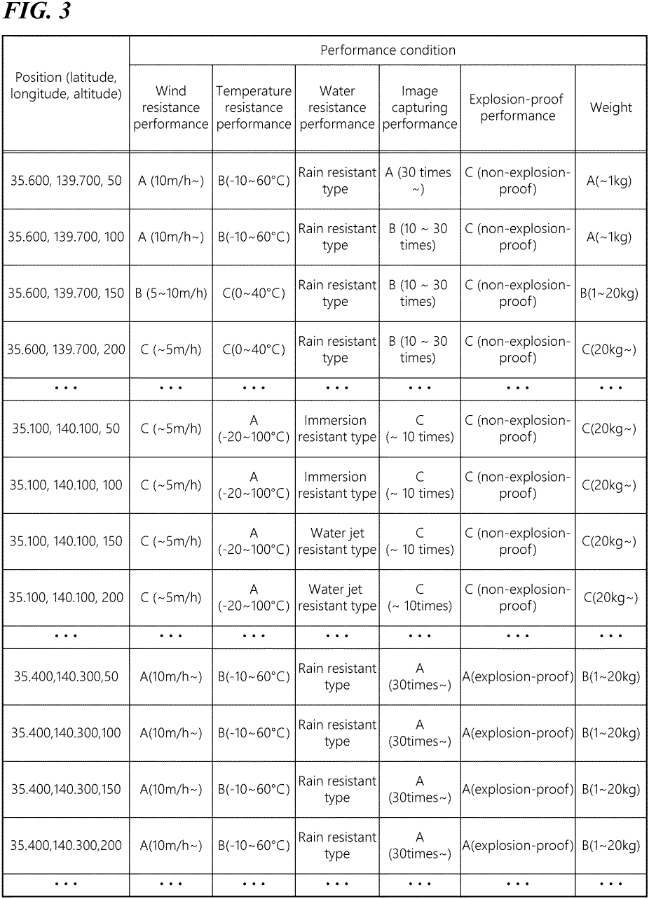

FIG. 3 is a diagram showing an example of performance condition data. In the performance condition data shown in FIG. 3, positions represented by latitude, longitude, and altitude (m) are associated with a plurality of performance conditions. The types of the plurality of performance conditions in the example shown in FIG. 3 are wind resistance performance, temperature resistance performance, water resistance performance, image capturing performance, explosion-proof performance, and flight vehicle weight, however, the performance conditions are not limited to these. Symbols A, B, and C in FIG. 3 indicate the levels of performance required. The storage unit 12 stores specific content of each performance level for each type of performance condition.

Wind resistance performance is represented by the maximum wind speed at which a flight vehicle can fly stably. For example, Level A means performance with the maximum allowable wind speed at which it is possible to fly is 10 m/h or higher, Level B means performance with the maximum allowable wind speed at which it is possible to fly is 5 to 10 m/h, and Level C means performance with the maximum allowable wind speed at which it is possible to fly is 5 m/h or lower. A high level of wind resistance performance is required when a flight vehicle is to fly in an area where the wind is strong, or in an area where there are many buildings, railway overhead wires, and so forth in the surrounding area.

Temperature resistance performance is represented by a temperature range in which a flight vehicle can fly stably. For example, level A corresponds to the range of -20° C. to 100° C., level B corresponds the range of -10° C. to 60° C., and level C corresponds to the range of 0° C. to 40° C. A high level of temperature resistance performance is required in those cases where the flight vehicle is flying near a facility with high temperatures (for example, a facility on fire) or where the flight vehicle is flying in an area with a very high or very low temperature.

Water resistance performance is represented by the maximum allowable amount of water to which the flight vehicle can be exposed per unit time. The water resistance performance corresponds to, for example, the protection grading defined by JIS. As an example, level A is a level at which ingress of water into the interior does not occur even when continuously submerged in water, level B is a level at which water jets from any direction will not result in any harmful effects, and level C is a level at which water droplets falling from the vertical will not result in any harmful effects. Level A water resistance performance is required when a flight vehicle flies over seas or rivers, or the flight vehicle flies in rainy weather.

Image capturing performance is represented by, for example, a zoom magnification. For example, level A corresponds to a zoom magnification of 30 times or higher, level B corresponds to a zoom magnification of 10 times or higher, and level C corresponds to a zoom magnification of less than 10 times. The higher the zoom ratio, the greater the distance at which image capturing can be performed. Therefore, image capturing performance of level A is required when the flight vehicle flies in areas where there are buildings or overhead wires, in the vicinity of which flight is not allowed. It should be noted that the image capturing performance may be represented by the number of cameras or the positions at which the cameras are provided.

Explosion-proof performance is represented by the level of impact that the flight vehicle is subjected to in the presence of a combustible gas. Level A is a level that allows flight in locations where an explosive gas or steam is present, Level B is a level that allows flight in locations where explosive particles are present, and Level C is a level of having no explosion-proof structure. A high level of explosion-proof performance is required when the flight vehicle flies over a chemical complex or a fire site.

Weight is the combined weight of the flight vehicle main body and the object being carried by the flight vehicle. For example, level A is less than 1 kg, level B is 1 kg or more and less than 20 kg, and level C is 20 kg or more. A small weight is required when the flight vehicle flies in an area where a severe human detriment to human health is likely if a flight vehicle crashes, or above an important facility.

The condition storage unit 121 may further store a required weather condition indicating a weather condition under which the flight vehicle is permitted to fly at each of the plurality of positions. For example, in an area with buildings nearby, the risk of a flight vehicle coming into contact with buildings increases in rain, dense fog, or strong winds, and accordingly, in an area with buildings nearby, the required weather condition may be there is no adverse weather, such as a condition with rain, dense fog or strong winds.

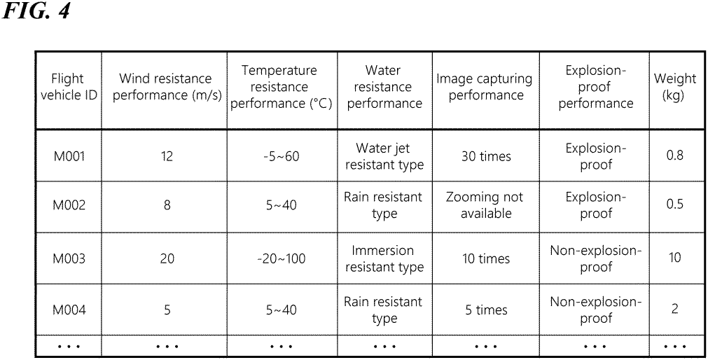

The mobile object information storage unit 122 stores flight vehicles data including information related to preliminarily registered flight vehicles. FIG. 4 is a diagram showing an example of the flight vehicles data. In the flight vehicles data shown in FIG. 4, each flight vehicle ID is associated with wind resistance performance, temperature resistance performance, water resistance performance, image capturing performance, explosion-proof performance, and weight.

Next, the control unit 13 will be described in detail. The control unit 13 executes a program stored in the storage unit 121 to thereby function as an application acceptance unit 131 and a movement permission unit 132.

Via the communication unit 11, the application acceptance unit 131 accepts application data for requesting permission for the applying flight vehicle D to fly and movement range data indicating the area in which the applying flight vehicle D is desired to fly. The application acceptance unit 131 may accept the application data and the movement range data at the same time, or may accept them separately. The application acceptance unit 131 notifies the movement permission unit 132 of the application data and the movement range data.

The movement permission unit 132 determines whether or not the performance of the applying flight vehicle D included in the application data satisfies the performance condition stored in the condition storage unit 121 in association with one or more positions included in the desired movement area indicated by the movement range data. The desired movement area is a path or region along or in which the user of the applying flight vehicle D desires to fly the applying flight vehicle D.

If the performance of the applying flight vehicle D satisfies the required performance, the movement permission unit 132 executes the processing of permitting flight corresponding to the application data, and executes the processing of not permitting flight corresponding to the application data if the required performance is not satisfied. The movement permission unit 132 may use, instead of the performance of the applying flight vehicle D included in the application data, the performance stored in the mobile object information storage unit 122 in association with the flight vehicle ID included in the application data as the performance of the applying flight vehicle D.

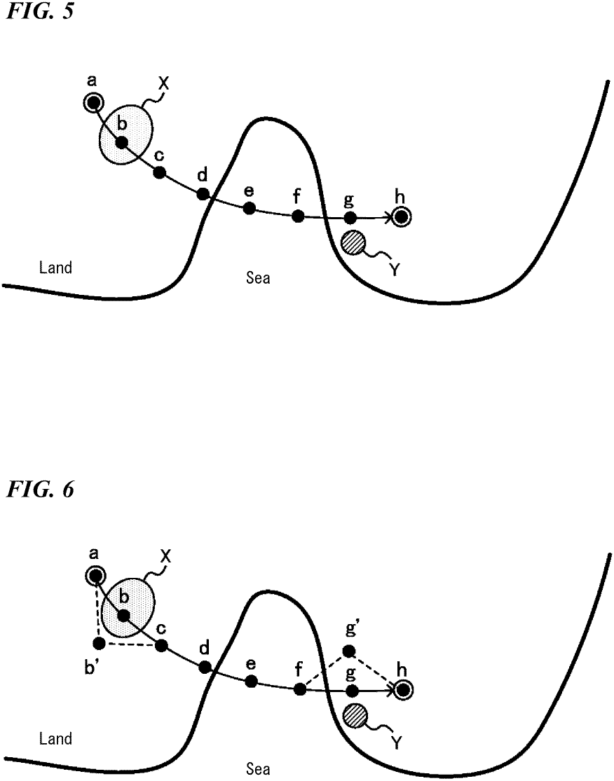

FIG. 5 is a diagram showing an example of a path corresponding to the movement range data. FIG. 5 shows a flight path from a point “a” to a point “h”. In order to determine whether or not to permit flight, the movement permission unit 132 first identifies a plurality of positions included in the movement range data, and identifies the performance condition stored in the condition storage unit 121 in association with each of the plurality of positions.

For example, the movement permission unit 132 executes the processing of permitting flight corresponding to the application data if the performance of the applying flight vehicle D satisfies the strictest performance condition among the plurality of the performance conditions stored in the condition storage unit 121 in association with the plurality of positions included in the desired movement area. Therefore, the movement permission unit 132 identifies, for each type of performance condition, the position with the highest required level among the plurality of positions included in the desired movement area, and determines whether or not the performance of the applying flight vehicle D satisfies the performance condition.

As an example, among the plurality of points on the path shown in FIG. 5, a point “b”, which is above a downtown X with many tall buildings, requires a higher performance level in terms of wind resistance performance, image capturing performance, and weight than other points. The point “b” is, for example, a position corresponding to latitude 35.600, longitude 139.700, and altitude 50 m in FIG. 3. At this position, level A is required for wind resistance performance, image capturing performance, and weight.

If the applying flight vehicle D is a flight vehicle with flight vehicle ID M001 shown in FIG. 4, the movement permission unit 132 determines that all the performance conditions required at the point “b” are satisfied. If the applying flight vehicle D is a flight vehicle with flight vehicle ID M002 shown in FIG. 4, the wind resistance performance and the image capturing performance thereof are determined as not satisfying the performance conditions required at the point “b”.

Points “e” and “f” are on the sea, and require a high level of water resistance performance. The point “e” is, for example, a position corresponding to latitude 35.100, longitude 140.100, and altitude 150 m in FIG. 3. At this position, water resistance performance of level B is required. If the applying flight vehicle D is a flight vehicle with flight vehicle ID M001 shown in FIG. 4, the movement permission unit 132 determines that the performance condition required at the point “e” is satisfied.

In the vicinity of a point “g” there is a chemical complex Y, and a high level of explosion-proof performance is required. The point “g” is, for example, a position corresponding to latitude 35.400, longitude 140.300, and altitude 100 m in FIG. 3. At this position, explosion-proof performance of level A is required. If the applying flight vehicle D is a flight vehicle with flight vehicle ID M001 shown in FIG. 4, the movement permission unit 132 determines that the performance condition required at the point “g” is satisfied.

If the performance of the applying flight vehicle D satisfies the strictest level of the performance conditions at the plurality of positions indicated by the movement range data in all types included in the performance conditions, the movement permission unit 132 permits the applying flight vehicle D to fly. That is to say, if the performance of the applying flight vehicle D satisfies the performance conditions that are required at all of the plurality of positions, which is indicated by the movement range data, the movement permission unit 132 permits the applying flight vehicle D to fly. If determined to permit the applying flight vehicle D to fly, the movement permission unit 132 transmits movement permitted notification data to the user terminal 2 that transmitted the application data for the flight of the applying flight vehicle D.

If determined not to permit the applying flight vehicle D to fly, the movement permission unit 132 transmits movement not-permitted notification data to the user terminal 2 that transmitted the application data for the flight of the applying flight vehicle D. Together with transmitting the movement not-permitted notification data, the movement permission unit 132 may also notify of the type of performance that does not satisfy the required performance condition, or notify the position at which the performance condition is not satisfied.

Furthermore, if the flight can be permitted provided that a change is made to some of the plurality of positions indicated by the movement range data, the movement permission unit 32 may notify the user terminal 2 of a recommended position. For example, the movement permission unit 132 transmits to the user terminal 2 the plurality of positions corresponding to the movement range data and image data indicating a recommended position superimposed on the map.

FIG. 6 is a diagram showing an example of an image indicating a recommended position. In order to identify such a recommended position, the movement permission unit 132 identifies a position at which the performance of the applying flight vehicle D satisfies the required performance condition, within a predetermined distance from the position at which the performance of the applying flight vehicle D has been determined as not satisfying the required performance condition. The predetermined distance is, for example, a distance obtained by multiplying the total flight distance indicated by the movement range data by a predetermined percentage (for example, 10%). FIG. 6 shows a recommended position “b′” for the point “b” and an alternative position “g′” for the point “g”.

The movement permission unit 132 may specify the closest position among the positions at which the performance of the applying flight vehicle D satisfies the required performance condition, and if the distance between the position indicated by the movement range data and the identified position is within a threshold value, may notify of the identified position as a recommended position. The movement permission unit 132 operating in this manner makes it easier for the user of the applying flight vehicle D to determine whether the path should be changed.

In a case where the condition storage unit 121 stores required weather statuses in association with locations, the movement permission unit 132 may execute the processing of permitting a flight corresponding to the application data if the weather status at one or more positions included in the desired movement area included in the application data further satisfies the required weather status stored in the condition storage unit 121 in association with the one or more positions. The movement permission unit 132 operating in this manner makes it possible to reduce the risk of the flight vehicle colliding with a building in bad weather.

The above description exemplified the case where the movement permission unit 132 makes reference to the performance condition data in which performance condition differs for each position to thereby determine whether or not to permit flight of the applying flight vehicle D as shown in FIG. 3. However, the performance condition may vary depending on factors other than position. Hereinafter there is described operations in the case where the performance condition varies depending on factors other than position.

### (Weather Status)

The flight stability and safety of a flight vehicle are affected by the weather in the flight area. Therefore, the condition storage unit 121 may store the performance condition in further association with each of a plurality of weather statuses. Examples of the plurality of weather statuses include wind speed, wind direction, amount of rainfall, amount of snowfall, and temperature. Specifically, the condition storage unit 121 may store the required level for each performance condition item in association with each of the plurality of weather statuses, for each position included in the performance condition data shown in FIG. 3.

In such a case, the movement permission unit 132 executes the processing of permitting a flight corresponding to the application data if the performance condition stored in the condition storage unit 121 in association with a weather status at one or more positions included in the desired movement area included in the application data is satisfied. The movement permission unit 132 first acquires, from an external server, weather status data (for example, weather forecast data) of each position at the time when the applying flight vehicle D is to pass through the scheduled flight position, and identifies the weather status at each position based on the acquired weather status data.

Subsequently, the movement permission unit 132 identifies the performance condition associated with the identified weather status in the performance condition data, for each position included in the desired movement area. If the performance of the applying flight vehicle D satisfies the performance condition corresponding to each position, the movement permission unit 132 permits the applying flight vehicle D to fly. The movement permission unit 132 using a different performance condition depending on the weather status in this manner can increase the probability of permitting the flight of the applying flight vehicle D, compared to the case of determining whether or not to permit flight based on one performance condition assuming the worst weather status.

If it is determined that the applying flight vehicle D cannot be permitted to fly, the movement permission unit 132 may notify the user terminal 2 of the result of determining whether or not the applying flight vehicle D is allowed to fly by changing the flight time to the time at which the weather status is to improve. In order to perform this, first, based on the weather status data corresponding to before or after the time at which the applying flight vehicle D is scheduled to fly, the movement permission unit 132 identifies the time at which the weather is to improve and the weather status after the improvement. The movement permission unit 132 makes reference to the performance condition required for the identified weather status, and thereby determines whether or not the flight of the applying flight vehicle D can be permitted.

If it is determined that the applying flight vehicle D can be permitted to fly by changing the flight time, the movement permission unit 132 notifies the user terminal 2 of the time after the change, together with that the flight can be permitted as long as the flight is made at the time. Then, if the application acceptance unit 131 acquires the application data with the changed flight time, the movement permission unit 132 determines again whether or not the applying flight vehicle D can be permitted to fly, and transmits movement permitted notification data to the user terminal 2 if the applying flight vehicle D can be permitted to fly. The movement permission unit 132 operating in this manner makes it possible for the user to change the flight time to thereby fly the applying flight vehicle D.

### (Date and Time)

The number of people in the area in which the flight vehicle flies or the operational status of facilities present in the area in which the flight vehicle flies may vary depending on the day and time of day on and at which the flight vehicle flies. Therefore, the condition storage unit 121 may store the performance condition in further association with a date or a time of day. Specifically, the condition storage unit 121 may store the required level for each performance condition item in association with a plurality of dates, days of week, and times of day, or combinations thereof, for each position included in the performance condition data shown in FIG. 3.

In such a case, the movement permission unit 132 executes the processing of permitting a flight corresponding to the application data if the performance condition stored in the condition storage unit 121 in association with the desired movement date and time included in the application data is satisfied. If it is determined that the applying flight vehicle D cannot be permitted to fly on and at the desired movement date and time, the movement permission unit 132 may notify the user terminal 2 of a date and time on and at which the applying flight vehicle D can be permitted to fly, among other dates and times before or after the desired movement date and time.

The movement permission unit 132 identifies, for example, the date and time on and at which the level of performance condition that caused the determination not to permit the applying flight vehicle D to fly is lower than the level corresponding to the desired movement date and time. If the performance of the applying flight vehicle D is determined as satisfying the required performance condition on and at the identified date and time, the movement permission unit 132 notifies the user terminal 2 of the identified date and time, together with that the flight can be permitted if the flight is to be made on and at these date and time.

### (Purpose or Operation Type of Flight Vehicle)

The performance condition required for a flight vehicle may vary, depending on the purpose or operation type of the flight vehicle. Examples of purpose or operation type of the flight vehicle include logistics (transportation of goods), image capturing, surveying, monitoring, and pesticide spraying. When a flight vehicle transports goods, it is assumed that the condition of required performance is stricter than that in the case of not transporting goods. Also, in the case of performing image-capturing in a direction different from the direction in which the flight vehicle is flying, it is unsafe not to provide a function to avoid collisions with other flight vehicles.

Therefore, the condition storage unit 121 may store the performance condition in further association with a purpose or operation type of the flight vehicle. In such a case, the movement permission unit 132 executes the processing of permitting a flight corresponding to the application data if the performance condition stored in the condition storage unit 121 in association with the purpose or operation type included in the application data is satisfied.

### Processing Flow of Operation Management Device 1

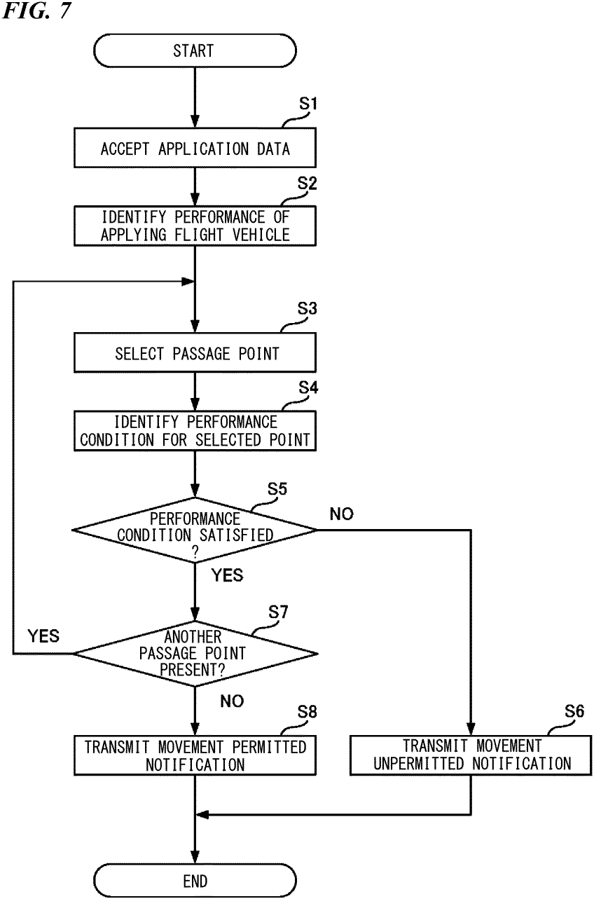

FIG. 7 is a flowchart showing the flow of processing of the operation management device 1. In the flowchart shown in FIG. 7, the processing starts when the application acceptance unit 131 has accepted application data and movement range data (S1).

Based on information indicating the performance of the applying flight vehicle D included in the application data or on information indicating the performance stored in the mobile object information storage unit 122 in association with the flight vehicle ID of the applying flight vehicle D, the movement permission unit 132 identifies the performance of the applying flight vehicle D (S2). Also, the movement permission unit 132 selects one passage point among a plurality of passage points included in the movement range data (S3).

Subsequently, the movement permission unit 132 makes reference to the condition storage unit 121 and thereby identifies the performance condition corresponding to the selected passage point (S4). The movement permission unit 132 determines whether or not the performance of the applying flight vehicle D satisfies the identified performance condition (S5). If the performance of the applying flight vehicle D is determined as not satisfying the identified performance condition (NO in S5), the movement permission unit 132 transmits movement not-permitted notification data to the user terminal 2 (S6).

On the other hand, if the performance of the applying flight vehicle D is determined as satisfying the identified performance condition (YES in S5), the movement permission unit 132 confirms whether or not another passage point is present (S7), and if another passage point is present (YES in S7), the processing returns to S3 to select the next passage point (S3). If the determination of S5 is performed for all passage points included in the movement range data (NO in S7), the movement permission unit 132 determines the performance of the applying flight vehicle D as satisfying the performance condition required at all of the passage points, and transmits movement permitted notification data to the user terminal 2 (S8).

### Modified Example

The above description assumed that the user of the applying flight vehicle D was unaware of the performance condition required at each position at the time of making a flight application for the applying flight vehicle D. However, if the user of the applying flight vehicle D is aware of the performance condition required at each position, it is possible to lower the probability of making an application that will not be permitted. The application acceptance unit 131 may, before accepting the application data, transmit the performance condition to the user terminal 2 in association with at least some positions of the plurality of positions.

For example, upon acquiring from the user terminal 2 information indicating the area in which the user desires to fly the applying flight vehicle D, the application acceptance unit 131 notifies the user terminal 2 of the required performance condition in association with a position at which relatively higher performance condition is required, among the plurality of positions included in this area. The application acceptance unit 131 may, before accepting the application data, accept the movement range data from the user terminal 2 and transmit the performance condition to the user terminal 2 in association with one or more positions included in this movement range data. The application acceptance unit 131 may transmit the required performance condition to the user terminal 2 in association with weather status, date and time, and purpose or operation type.

In this way, as a result of the application acceptance unit 131 providing the user with the required performance condition before the user applies for flying the applying flight vehicle D, it is possible for the user to first select a path that is satisfied by the performance of the applying flight vehicle D of their own and then apply for flying the applying flight vehicle D, or apply for flying by an appropriate applying flight vehicle D. Therefore, it is possible to suppress a wasted application from being made.

### Second Exemplary Embodiment

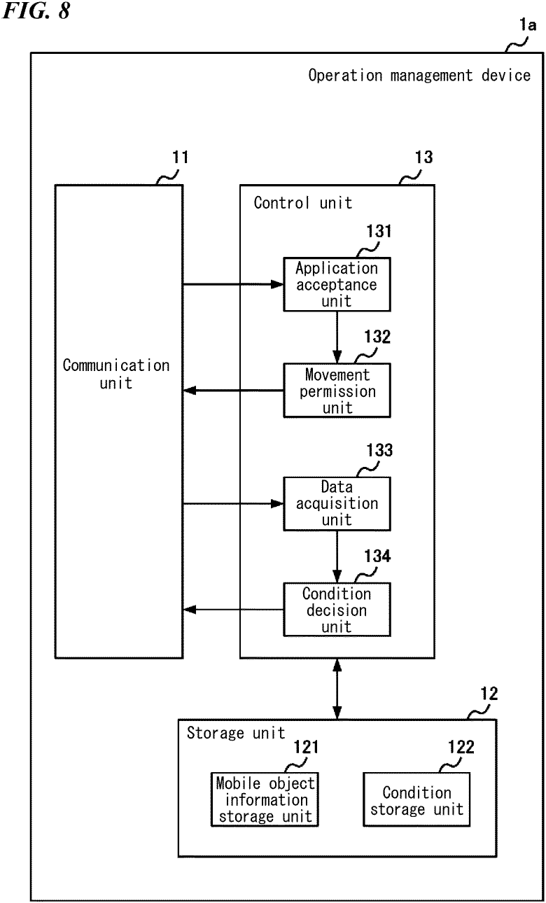

The first exemplary embodiment exemplified the case where the required performance condition is predetermined. A second exemplary embodiment differs from the first exemplary embodiment in that the performance condition is changed depending on the situation. FIG. 8 is a diagram showing a configuration of an operation management device 1a according to the second exemplary embodiment. The operation management device 1a shown in FIG. 8 is different from the operation management device 1 shown in FIG. 2 in that a data acquisition unit 133 and a condition decision unit 134 are further included, and is the same as the operation management device 1 in other respects.

The data acquisition unit 133 acquires data indicating the number of flight vehicles that are flying at positions within a predetermined distance from a plurality of positions included in movement range data. A position within the predetermined distance is a position at which the applying flight vehicle D may collide with another while flying at any of the plurality of positions, and is defined based on the flight speed of the applying flight vehicle D. The predetermined distance is, for example, 100 m.

The condition decision unit 134 decides the performance condition associated with the plurality of positions, based on the number of flight vehicles indicated by the data acquired by the data acquisition unit 133. The greater the number of flight vehicles within the predetermined distance from a certain position, the stricter the performance condition required at this position is made. For example, if the number of flight vehicles within the predetermined distance from a certain position is equal to or greater than a threshold value, the condition decision unit 134 tightens up by one step the level of required wind resistance performance, which affects the stability of flight, relative to the case where the number of flight vehicles is less than the threshold value. With the condition decision unit 134 deciding the performance condition in this manner, the movement permission unit 132 can permit only the applying flight vehicle D that is suitable for the surrounding conditions of the position at which the applying flight vehicle D is flying, and therefore flight safety is improved.

It should be noted that the condition decision unit 134 may change the performance condition, based on other information instead of the number of flight vehicles. As an example, the condition decision unit 134 may temporarily change the performance condition for a particular date, based on instructions sent from an organization that manages the operation of mobile objects or weather forecast data. In the case where the required performance condition is changed in this manner, the movement permission unit 132 may determine whether or not the performance of the applying flight vehicle D that has been permitted to move satisfies the performance condition after the change, and transmit a flight permission cancellation notification to the user terminal 2 if the performance condition is determined as not being satisfied. With the operation management device 1 operating in this manner, flight safety can be ensured even when the situation suddenly changes.

### Effects of Operation Management Device 1

As described above, the operation management device 1 permits the applying flight vehicle D to fly if the performance of the applying flight vehicle D, for which an application for flight (that is, movement) has been made, satisfies the performance condition required at the position included in the path along which the user of the applying flight vehicle D desires the applying flight vehicle D to fly. With the operation management device 1 configured in this manner, even in the case where influence on flight of a flight vehicle differs depending on the area, it is possible to fly, in an area, a flight vehicle that is appropriate for the area.

It should be noted that the present exemplary embodiment enables contribution to the Goal 9 of the United Nations-led Sustainable Development Goals (SDGs), “Build resilient infrastructure, promote sustainable industrialization, and foster innovation”.

As mentioned above, several techniques have been proposed in relation to operation management devices and operation management methods.

There are some cases where a particular mobile object cannot move in an area while another mobile object can move in the area. Nonetheless, in the conventional system, in an area where movement is not permitted, movement of mobile objects are prohibited across the board, and thus there is a problem that mobile objects cannot move at all in the area.

However, according to at least one of the exemplary embodiments, the invention produces an effect of, for example, enabling an area-appropriate mobile object to move within such an area.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims. For example, all or some of the devices can be functionally or physically distributed or integrated in arbitrary units. Also, a new embodiment resulting from arbitrary combinations of multiple embodiments is also included in the present exemplary embodiment. The effect of the new embodiment arising from the combination also has the effect of the original embodiment.

What is claimed is:

1. An operation management device comprising:
a condition storage unit that stores, in association with a plurality of positions, a performance condition required for a mobile object that moves at each of the plurality of positions;
an application acceptance unit that accepts application data for requesting permission for an applying mobile object to move, and movement range data indicating an area in which the applying mobile object is desired to move; and
a movement permission unit that executes processing of permitting a movement corresponding to the application data if performance of the applying mobile object included in the application data or performance of the applying mobile object stored in a mobile object information storage unit in association with mobile object identification information for identifying the applying mobile object included in the application data satisfies the performance condition stored in the condition storage unit in association with one or more positions included in a desired movement area indicated by the movement range data.

2. The operation management device according to claim 1, wherein
the movement permission unit executes the processing of permitting a movement corresponding to the application data if the performance of the applying mobile object satisfies the strictest performance condition among a plurality of the performance conditions stored in the condition storage unit in association with a plurality of positions included in the desired movement area.

3. The operation management device according to claim 1, wherein
the condition storage unit further stores a required weather condition indicating a weather condition under which the mobile object is permitted to move at each of the plurality of positions, and
the movement permission unit executes the processing of permitting a movement corresponding to the application data if the weather status at one or more positions included in the desired movement area included in the application data further satisfies the required weather condition stored in the condition storage unit in association with the one or more positions.

4. The operation management device according to claim 1, wherein
the condition storage unit stores the performance condition in further association with a weather status; and
the movement permission unit executes the processing of permitting a movement corresponding to the application data if the performance condition stored in the condition storage unit in association with the weather status at one or more positions included in the desired movement area included in the application data is satisfied.

5. The operation management device according to claim 1, wherein
the condition storage unit stores the performance condition in further association with a date or a time of day; and
the movement permission unit executes the processing of permitting a movement corresponding to the application data if the performance condition stored in the condition storage unit in association with desired movement date and time included in the application data is satisfied.

6. The operation management device according to claim 1, wherein
the condition storage unit stores the performance condition in further association with a purpose or an operation type of the mobile object; and
the movement permission unit executes the processing of permitting a movement corresponding to the application data if the performance condition stored in the condition storage unit in association with a purpose or an operation type included in the application data is satisfied.

7. The operation management device according to claim 1, further comprising:
a data acquisition unit that acquires data indicating the number of mobile objects that are moving at positions within a predetermined distance from the plurality of positions; and
a condition decision unit that decides the performance condition associated with the plurality of positions, based on the number of mobile objects indicated by the data acquired by the data acquisition unit.

8. The operation management device according to claim 1, wherein
the application acceptance unit, before accepting the application data, transmits the performance condition to an information terminal that transmits the application data in association with at least some positions of the plurality of positions.

9. The operation management device according to claim 8, wherein
the application acceptance unit, before accepting the application data, accepts the movement range data from the information terminal and transmits the performance condition to the information terminal in association with one or more positions included in this movement range data.

10. An operation management method executed by a computer, the method comprising:
accepting application data for requesting permission for an applying mobile object to move, and movement range data indicating an area in which the applying mobile object is desired to move; and
executing processing of permitting a movement corresponding to the application data if performance of the applying mobile object included in the application data or performance of the applying mobile object stored in a mobile object information storage unit in association with mobile object identification information for identifying the applying mobile object included in the application data satisfies the performance condition stored in the condition storage unit in association with one or more positions included in a desired movement area indicated by the movement range data, as the performance condition required for a mobile object that moves at one or more of the positions.
